(19) United States
(12) Patent Application Publication
(10) Pub. No.: US 2025/0233439 A1
(43) Pub. Date: Jul. 17, 2025

(54) TECHNIQUES FOR CHARGING MULTIPLE PARALLEL BATTERIES

(71) Applicant: QUALCOMM Incorporated, San Diego, CA (US)

(72) Inventors: Xinying DING, Cupertino, CA (US); Neal HOROVITZ, Los Altos, CA (US); Guoyong GUO, San Jose, CA (US); Kin Siu FUNG, San Jose, CA (US); Jonathan LUTY, San Diego, CA (US); Joseph Dale RUTKOWSKI, Chandler, AZ (US)

(21) Appl. No.: 18/800,783

(22) Filed: Aug. 12, 2024

Related U.S. Application Data
(60) Provisional application No. 63/621,065, filed on Jan. 15, 2024.

(51) Int. Cl. H02J 7/00

(52) U.S. Cl. CPC H02J 7/007182; H02J 7/0014; H02J 7/0047; H02J 7/00714; H02J 7/007192

(57) ABSTRACT

Certain aspects of the present disclosure are directed towards techniques and apparatus for battery charging. An example method generally includes: performing at least one first charging operation for each of a first battery and a second battery; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison.

### CROSS-REFERENCE TO RELATED APPLICATION

The present application for patent claims the benefit of priority to U.S. Provisional Patent Appl. No. 63/621,065, filed Jan. 15, 2024, which is hereby incorporated by reference herein in its entirety.

### TECHNICAL FIELD

Certain aspects of the present disclosure generally relate to power supply circuits and, more particularly, to techniques and apparatus for independently controlling the charging and managing of multiple batteries.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

A charge pump is a type of SMPS typically comprising at least one switching device to control the connection of a supply voltage across a load through a capacitor. In a voltage doubler (also referred to as a “multiply-by-two (X2) charge pump”), for example, the capacitor of the charge pump circuit may initially be connected across the supply, charging the capacitor to the supply voltage. The charge pump circuit may then be reconfigured to connect the capacitor in series with the supply and the load, doubling the voltage across the load. This two-stage cycle is repeated at the switching frequency for the charge pump. Charge pumps may be used to multiply or divide voltages by integer or fractional amounts, depending on the circuit topology.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure are directed towards a method for battery charging. The method generally includes: performing at least one first charging operation for each of a first battery and a second battery; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison.

Certain aspects of the present disclosure are directed towards a charging circuit. The charging circuit generally includes a power supply configured to perform at least one first charging operation for each of a first battery and a second battery, a charging controller coupled to the power supply and configured to: detect a first voltage associated with the first battery and a second voltage associated with the second battery; and compare the first voltage and the second voltage to detect whether the first voltage and the second voltage are balanced, wherein the power supply is further configured to perform a second charging operation for one of the first battery and the second battery to balance the first voltage and the second voltage based on the comparison.

Certain aspects of the present disclosure are directed towards a method for battery charging. The method generally includes: performing at least one first charging operation for each of a first battery and a second battery, wherein performing the at least one first charging operation comprises biasing a first transistor coupled between a supply voltage node and the first battery in a linear region for the first transistor and biasing a second transistor coupled between the supply voltage node and the second battery in a linear region for the second transistor; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison.

Certain aspects of the present disclosure are directed towards a charging circuit. The charging circuit generally includes: a power supply configured to perform at least one first charging operation for each of a first battery and a second battery, wherein, during the at least one first charging operation, a first transistor coupled between a supply voltage node and the first battery is configured to be biased in a linear region for the first transistor and a second transistor coupled between the supply voltage node and the second battery is configured to be biased in a linear region for the second transistor; and a charging controller coupled to the power supply and configured to: detect a first voltage associated with the first battery and a second voltage associated with the second battery; and compare the first voltage and the second voltage to detect whether the first voltage and the second voltage are balanced, wherein the power supply is further configured to perform a second charging operation for one of the first battery and the second battery to balance the first voltage and the second voltage based on the comparison.

Certain aspects of the present disclosure are directed towards a method for battery charging. The method generally includes: performing at least one first charging operation for each of a first battery and a second battery; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison, wherein the second charging operation to balance the first voltage and the second voltage are performed after the first voltage and the second voltage have reached a threshold voltage.

Certain aspects of the present disclosure are directed towards a charging circuit. The charging circuit generally includes: a power supply configured to perform at least one first charging operation for each of a first battery and a second battery; and a charging controller coupled to the power supply and configured to: detect a first voltage associated with the first battery and a second voltage associated with the second battery; and compare the first voltage and the second voltage to detect whether the first voltage and the second voltage are balanced, wherein the power supply is further configured to perform a second charging operation for one of the first battery and the second battery to balance the first voltage and the second voltage based on the comparison, wherein the charging controller is configured to perform the second charging operation to balance the first voltage and the second voltage after the first voltage and the second voltage have reached a threshold voltage.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power management integrated circuit (PMIC) and a battery charging circuit, in which aspects of the present disclosure may be practiced.

FIG. 2 is a circuit diagram of an example power supply circuit, in accordance with certain aspects of the present disclosure.

FIG. 3 is a circuit diagram of an example power supply circuit including a switched-mode power supply (SMPS) circuit and multiple independently controlled charging paths, in accordance with certain aspects of the present disclosure.

FIG. 4 is a flow diagram illustrating example operations for battery charging, in accordance with certain aspects of the present disclosure.

FIG. 5 is a circuit diagram of a charging circuit which may include a power supply circuit during a full-on charging mode, in accordance with certain aspects of the present disclosure.

FIG. 6 illustrates an averaging circuit used to control a power stage of an SMPS based on sensed battery currents, in accordance with certain aspects of the present disclosure.

FIG. 7 illustrates an averaging circuit used to control a power stage of an SMPS with amplifiers for current control, in accordance with certain aspects of the present disclosure

FIG. 8 is a circuit diagram of a charging circuit including amplifiers for voltage and current control, in accordance with certain aspects of the present disclosure

FIG. 9 is a flow diagram of example operations for battery charging, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for independently controlling the charging and managing of multiple independent batteries using a power supply circuit that includes a switching regulator and multiple independently controlled and monitored charging paths. Certain aspects are directed toward balancing battery voltages for multiple batteries. The balancing may be performed by continuing a linear fast charge operation for a battery having a lower voltage than another battery before transitioning to a full-on charging mode. Some aspects also provide current-limiting techniques by adjusting an on-resistance of one or more transistors coupled between respective batteries and a supply voltage for charging. Certain aspects also provide a circuit for regulating a total charging current for multiple batteries during full-on charging mode. For example, the total charging current may be regulated via an averaging circuit to be equal to an average of the charging currents for the batteries, as described in more detail herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### AN EXAMPLE DEVICE

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

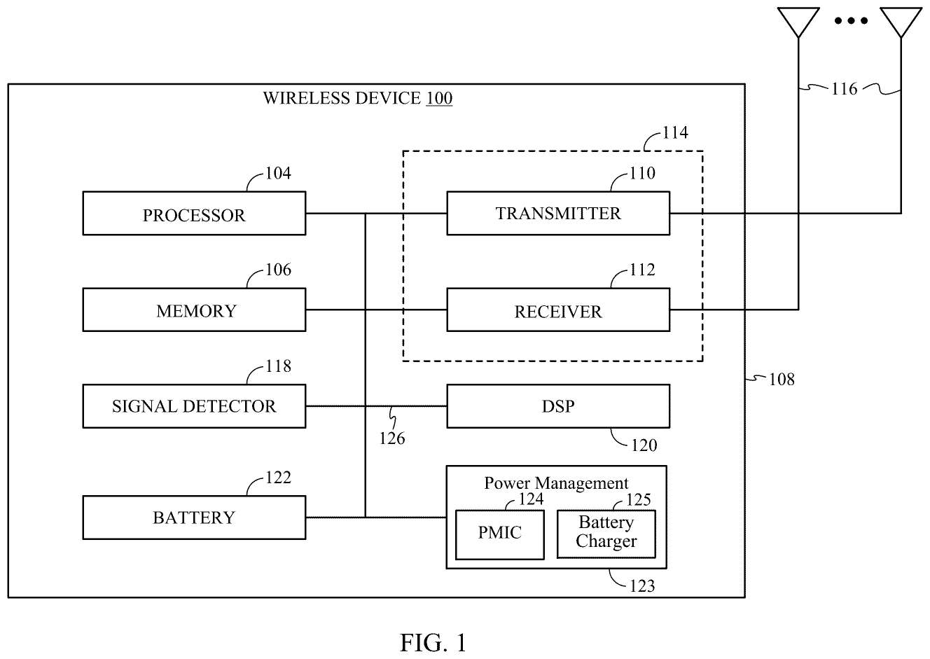

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

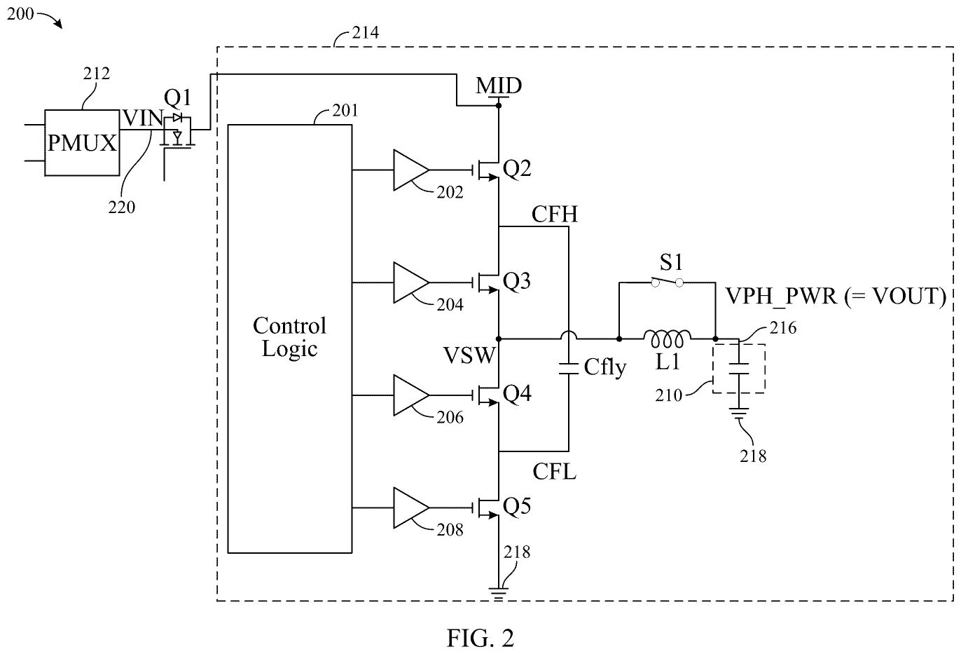

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits, such as a battery charger 125, which may be controlled by the PMIC or logic associated with the battery charger, for example. For certain aspects, at least a portion of one or more of the power supply circuits (e.g., at least a portion of the battery charger 125) may be integrated in the PMIC 124. The PMIC 124 and/or the one or more power supply circuits may include at least a portion of a switched-mode power supply (SMPS) circuit, which may be implemented by any of various suitable switched-mode power supply circuit topologies, such as a two-level buck converter, a three-level buck converter, a charge pump, or an adaptive combination power supply circuit (e.g., the SMPS circuit 214 of FIG. 2), which can switch between operating in a buck converter mode and a charge pump mode, as described below.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Circuits and Operation

As described above, the PMIC 124 and/or the one or more power supply circuits (e.g., battery charger 125) may include at least a portion of an SMPS circuit (e.g., a buck converter, a charge pump converter, or an adaptive combination power supply circuit capable of switching therebetween), which may be a single-phase or multi-phase converter. In the case of an adaptive combination power supply circuit, both converter modes may be single-phase, both converter modes may be multi-phase, one converter mode may be single-phase while the other converter mode is multi-phase or capable of changing between single-phase and multi-phase, or one converter mode may be multi-phase while the other converter mode is capable of changing between single-phase and multi-phase.

FIG. 2 is a circuit diagram of an example power supply circuit 200, which may be used to charge one or more batteries. As illustrated, the power supply circuit 200 includes a power multiplexer 212 (labeled “PMUX”), a reverse-current-blocking transistor Q1 (which may also be referred to as an overvoltage protection (OVP) field-effect transistor (FET) or an input FET), and an SMPS circuit 214 (e.g., an adaptive SMPS circuit).

The power multiplexer 212 may be configured to select between receiving power from, for example, (i) a Universal Serial Bus (USB) port for connecting to a wall adapter and (ii) a wireless power port (both not shown). The power multiplexer 212 may be implemented as a single-pole, double-throw (SPDT) switch by two OVP FETs, and in this case, transistor Q1 may be eliminated.

In certain aspects, the output of the power multiplexer 212 may be coupled to an input voltage node 220 (labeled “VIN”). The input voltage node 220 may be coupled to a source of the transistor Q1, and a drain of the transistor Q1 may be coupled to a voltage node (labeled “MID”) of the SMPS circuit 214. The MID voltage node may serve as the power supply rail of the SMPS circuit 214, and in some cases, may alternatively be considered as an input node of the SMPS circuit. In some cases, the power multiplexer 212 and/or transistor Q1 may be removed.

For certain aspects, the SMPS circuit 214 may have a two-level buck converter topology. For other aspects, the SMPS circuit 214 may have a single-phase three-level buck converter topology (as illustrated in the power supply circuit 200 of FIG. 2), and may include a second transistor Q2, a third transistor Q3, a fourth transistor Q4, a fifth transistor Q5, a flying capacitive element Cfly, an inductive element L1, and a load 210, which is represented here by a capacitor. For other aspects, the SMPS circuit 214 may have a dual-phase three-level buck converter topology. To realize an adaptive SMPS circuit, a switch S1 may be added across the inductive element L1 of the three-level buck converter topology. With the switch S1 closed, the adaptive SMPS circuit may function as a single-phase divide-by-two (Div2) charge pump converter, as further described below. In certain aspects, switch S1 may be implemented by two back-to-back transistors.

Transistor Q3 may be coupled to transistor Q2 via a first node (labeled “CFH” for flying capacitor high node), transistor Q4 may be coupled to transistor Q3 via a second node (labeled “VSW” for voltage switching node), and transistor Q5 may be coupled to transistor Q4 via a third node (labeled “CFL” for flying capacitor low node). For certain aspects, the transistors Q2-Q5 may be implemented as n-type metal-oxide-semiconductor (NMOS) transistors, as illustrated in FIG. 2. In this case, the drain of transistor Q3 may be coupled to the source of transistor Q2, the drain of transistor Q4 may be coupled to the source of transistor Q3, and the drain of transistor Q5 may be coupled to the source of transistor Q4. The source of transistor Q5 may be coupled to a reference potential node 218 (e.g., electric ground) for the power supply circuit 200. The flying capacitive element Cfly may have a first terminal coupled to the first node and a second terminal coupled to the third node. The inductive element L1 may have a first terminal coupled to the second node and a second terminal coupled to an output voltage node 216 (labeled “VOUT,” which may also be referred to as “VPH_PWR” or “VPH”) and the load 210.

Control logic 201 may control operation of the SMPS circuit 214 and other aspects of the power supply circuit 200. For example, the control logic 201 may control operation of the transistors Q2-Q5 via output signals to the inputs of respective gate drivers 202, 204, 206, and 208. The outputs of the gate drivers 202, 204, 206, and 208 are coupled to respective gates of transistors Q2-Q5. During operation of the adaptive SMPS circuit (or of a three-level buck converter), the control logic 201 may cycle through four different phases, which may differ depending on whether the duty cycle is less than 50% or greater than 50%.

Operation of the adaptive SMPS circuit with a duty cycle of less than 50% is described first. In a first phase (referred to as a “charging phase”), transistors Q2 and Q4 are activated, and transistors Q3 and Q5 are deactivated, to charge the flying capacitive element Cfly and to energize the inductive element L1. In a second phase (called a “holding phase”), transistor Q2 is deactivated, and transistor Q5 is activated, such that the VSW node is coupled to the reference potential node, the flying capacitive element Cfly is disconnected (e.g., one of the Cfly terminals is floating), and the inductive element L1 is deenergized. In a third phase (referred to as a “discharging phase”), transistors Q3 and Q5 are activated, and transistor Q4 is deactivated, to discharge the flying capacitive element Cfly and to energize the inductive element L1. In a fourth phase (also referred to as a “holding phase”), transistor Q4 is activated, and transistor Q3 is deactivated, such that the flying capacitive element Cfly is disconnected and the inductive element L1 is deenergized.

Operation of the adaptive SMPS circuit with a duty cycle greater than 50% is similar in the first and third phases, with the same transistor configurations. However, in the second phase (called a “holding phase”) following the first phase, transistor Q4 is deactivated, and transistor Q3 is activated, such that the VSW node is coupled to the MID node, the flying capacitive element Cfly is disconnected, and the inductive element L1 is energized. Similarly in the fourth phase (also referred to as a “holding phase”) with a duty cycle greater than 50%, transistor Q2 is activated, and transistor Q5 is deactivated, such that the flying capacitive element Cfly is disconnected and the inductive element L1 is energized.

Furthermore, the control logic 201 may have a control signal (not shown in FIG. 2) configured to control operation of switch S1 and selectively enable divide-by-two (Div2) charge pump operation. For certain aspects, when this control signal is logic low, switch S1 is open, and the power supply circuit 200 operates as a three-level buck converter using the inductive element L1. When this control signal is logic high for certain aspects, switch S1 is closed, thereby shorting across the inductive element L1 and effectively removing the inductive element L1 from the circuit, such that the adaptive SMPS circuit operates as a Div2 charge pump. The control logic 201 may be configured to automatically control operation of switch S1 (e.g., through the logic level of the control signal) based on an output current (also referred to as a “load current”) and/or an input current for the adaptive SMPS circuit.

### Example Power Supply Circuit for Multi-Battery Charging

Many portable devices may use multiple independent batteries. In some cases, such as foldable and flip phones and Internet of things (IoT) devices, the multiple independent batteries include batteries of varying capacities (asymmetrical batteries) that often result in challenges for charging, monitoring, and balancing the batteries. At least some multi-battery charging implementations are complex and expensive in terms of cost and area, and may result in performance issues. For example, some multi-battery charging implementations use multiple separate charging circuits and employ impedance-balancing circuitry (e.g., a current limit switch) to balance the batteries (e.g., prevent one battery from charging or discharging faster than another).

Certain aspects of the present disclosure provide techniques and apparatus for charging multiple independent batteries using a power supply circuit that includes a switched-mode power supply (SMPS) and independently controlled and monitored charging paths. Such a power supply circuit may control and monitor the charging of multiple independent batteries without using multiple chargers. For example, the power supply circuit may include independently controlled charging paths for each battery, each charging path having a switch (e.g., battery FET) to provide charging control.

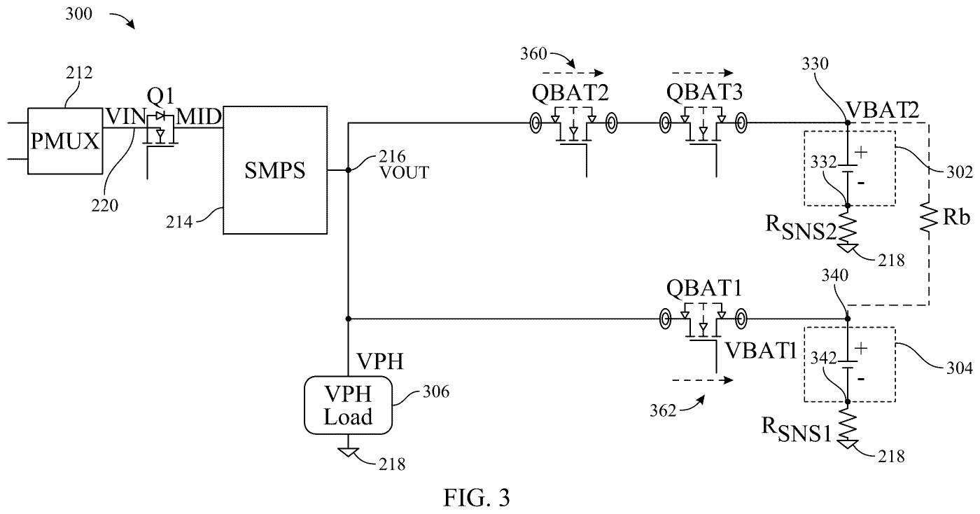

FIG. 3 is a circuit diagram of an example power supply circuit 300 that includes a switching regulator (e.g., the SMPS circuit 214) as a single charger and independently controlled charging paths (e.g., charging paths 360, 362), in accordance with certain aspects of the present disclosure. For certain aspects, the power supply circuit 300 may include the power multiplexer 212, the transistor Q1, and the SMPS circuit 214 (or another suitable SMPS circuit). The power supply circuit 300 may also include a load 306 (e.g., labeled “VPH Load”), a first switch (e.g., implemented by one or more transistors QBAT1), a second switch (e.g., implemented by one or more transistors QBAT2 and/or QBAT3), a first battery 304 (BAT1), a second battery 302 (BAT2), a first sense resistive element R_{SNS1}, a second sense resistive element R_{SNS2}, and a balancing resistive element Rb. For certain aspects, the batteries 302, 304 may be external to an integrated circuit (IC) (e.g., a PMIC), whereas at least a portion of the switching regulator and the switches (implemented by transistors QBAT1 and QBAT2) may be internal to the IC. The sense resistive elements R_{SNS1} and R_{SNS2} may be internal or external to the IC, or one sense resistive element may be internal while the other is external. For certain aspects, either or both of the sense resistive elements R_{SNS1} and R_{SNS2} may be eliminated, and the on-resistance(s) of the corresponding transistors QBAT1 and/or QBAT2 may be used as current-sensing resistor(s).

The load 306 may be analogous to the load 210 of FIG. 2. The load 306 may represent one or more circuits of a device (e.g., the device 100 of FIG. 1) that are powered internally by the switching regulator (e.g., with power supply rail VPH=VOUT). The load 306 may be coupled (in shunt) to the reference potential node 218.

In certain aspects, the first battery 304 and/or the second battery 302 may represent a single-cell (1S) battery, a two-cell-in-series (2S) battery, or more than two stacked cells in a battery (e.g., a multi-cell-in series battery). The charging architecture illustrated in FIG. 3 represents a one-cell-in-series, two-cells-in-parallel (1S2P) configuration. In some cases, the first battery 304 and the second battery 302 may be symmetrical batteries, having the same capacity (and size). In other cases, the first battery 304 and the second battery 302 may be asymmetrical batteries, each with a different capacity (and size). For example, the power supply circuit 300 may be included in a device that is foldable, which may include a first portion coupled to a second portion by a hinge. In this example, the first portion of the foldable device may include the first battery 304, and the second portion of the foldable device may include the second battery 302.

In certain aspects, the output voltage node 216 of the SMPS circuit 214 may be coupled to transistor(s) QBAT1, transistor(s) QBAT2, and the load 306. In certain aspects, one or more of transistors QBAT1 and QBAT2 may be bidirectional switches, each implemented with one or more transistors. In some cases, transistor(s) QBAT1 and/or QBAT2 may be implemented by back-to-back transistors or a body-switchable transistor, for example. The gates of the QBAT1 and QBAT2 transistors may be driven by logic circuitry (e.g., the control logic 201 of FIG. 2 or other logic not shown in FIG. 3).

In certain aspects, transistor(s) QBAT1 may be coupled to the first battery 304 via a first battery voltage node 340 (labeled “VBAT1”), and transistor(s) QBAT2 may be coupled to the second battery 302 via a second battery voltage node 330 (labeled “VBAT2”). The first battery 304 may be coupled to the first sense resistive element R_{SNS1} via another first battery voltage node 342 (e.g., coupled to the negative terminal of the first battery 304), and the second battery 302 may be coupled to the second sense resistive element R_{SNS2} via another second battery voltage node 332 (e.g., coupled to the negative terminal of the second battery 302). The first and second sense resistive elements R_{SNS1} and R_{SNS2} may function as sensing resistors to measure the current through the first battery 304 and the second battery 302, respectively.

When the batteries 302, 304 are external to an IC with other circuitry of the power supply circuit 300, the IC may include a positive first battery port (e.g., a pin) coupled to the first battery voltage node 340 and to the positive terminal of the first battery 304. In some cases, the IC may include a negative first battery port coupled to the other first battery voltage node 342, to the first sense resistive element R_{SNS1}, and to the negative terminal of the first battery 304. Additionally or alternatively, the IC may include a positive second battery port coupled to the second battery voltage node 330 and to the positive terminal of the second battery 302. In some cases, the IC may include a negative second battery port coupled to the other second battery voltage node 332, to the sense resistive element R_{SNS2}, and to the negative terminal of the second battery 302. The sense resistive elements R_{SNS1} and R_{SNS2} may be coupled to the reference potential node 218.

In certain aspects, the positive terminals of the first battery 304 and the second battery 302 may be coupled together via the balancing resistive element Rb. In some cases, the balancing resistive element Rb may be implemented as a 100 22 resistor, for example. The balancing resistive element Rb may be internal to the IC (coupled between the first battery voltage node 340 and the second battery voltage node 330) or may be external to the IC. The balancing resistive element Rb may be used to balance the two batteries during charging or when the device is powered off and the batteries 302, 304 begin discharging.

According to certain aspects, the power supply circuit 300 may perform charging (via the SMPS circuit 214) of both the first battery 304 and the second battery 302 through two independently controlled charging paths 360, 362. Electrical power received from a wall adapter or wireless charger, for example, at the power multiplexer 212 may be converted by the SMPS circuit 214 and used to independently charge the first battery 304 (e.g., through charging path 362) and the second battery 302 (e.g., charging path 360). For example, current from the output voltage node 216 may be routed to the first battery voltage node 340 via transistor(s) QBAT1 in the charging path 362, for charging the first battery 304. Similarly, current from the output voltage node 216 may be routed to the second battery voltage node 330 via transistor(s) QBAT2 in the charging path 360, for charging the second battery 302. In certain aspects, transistor(s) QBAT1 may be configured to independently control and monitor charging of the first battery 304 (via charging path 362), and transistor(s) QBAT2 may be configured to independently control and monitor charging of the second battery 302 (via charging path 360).

Having one or more transistors (e.g., transistor(s) QBAT1 or QBAT2) in each charging path may allow for independent charging control for the batteries, including trickle, pre-charge, constant current (CC), constant voltage (CV), and/or termination charging. In certain aspects, independently monitoring the charging of the multiple independent batteries may include independently monitoring the level of charge in the batteries via these transistors. Additionally or alternatively, independently monitoring the charging of the multiple independent batteries may include independent current sensing, battery measurement, and/or current limit regulation (total or individual) for the batteries. The presence of one or more transistors in each charging path may eliminate the use of impedance-balancing circuitry (e.g., a current limit switch) between the multiple independent batteries, because the transistor(s) in each charging path may be used to perform current limit regulation. For example, the power supply circuit 300 may lack a current limit switch between the first battery 304 and the second battery 302.

Certain aspects of the present disclosure may also provide flexibility in the end of charge for the batteries (e.g., battery end of charge may be dependent on current for a single battery, the total current for multiple batteries, or the battery state of charge (SOC)). The independent charging path switches (e.g., transistors QBAT1 and QBAT2) may be internal (integrated in the PMIC), or one or more of the switches may be external to the PMIC. The temperature of the batteries can be independently monitored and, based on the sensed battery temperature(s), appropriate action may be taken (e.g., charging may be suspended, charging voltage and/or current may be reduced, etc.) via the independent charging path switches. For example, when the temperature of the second battery 302 is too high, transistor(s) QBAT2 may be effectively opened, or the charging current may be reduced in increments or suspended.

According to certain aspects, the power supply circuit 300 may perform charging of a single battery (e.g., the first battery 304) using a single charger. For example, the second battery 302 may have been disconnected and/or removed from the power supply circuit 300. In this single-cell-in-series, single-cell-in-parallel (1S1P) configuration, transistor(s) QBAT2 may be used as a bypass switch (e.g., a bypass FET). The power supply circuit 300 may enable power-on for a device (e.g., device 100) when only a single battery is connected, and may also prevent over-charging of the single connected battery.

In some cases, it may be desirable to utilize parallel charging to charge multiple independent batteries to speed up charging (e.g., when the batteries have greater power levels). In some example parallel charging solutions, a main charger (e.g., the SMPS circuit 214) is capable of charging multiple independent batteries (e.g., the first battery 304 and the second battery 302) and providing power by itself or may be paralleled with one or more auxiliary chargers.

### Example Balanced Charging Operations

Certain aspects of the present disclosure are directed towards performing balanced charging of multiple batteries. The batteries may be part of a single-cell-in-series cell, two-cells-in-parallel (1S2P) configuration, as described herein. The balancing may be performed by continuing a linear fast charge operation for a battery having a lower voltage than another battery before transitioning to a full-on charging mode.

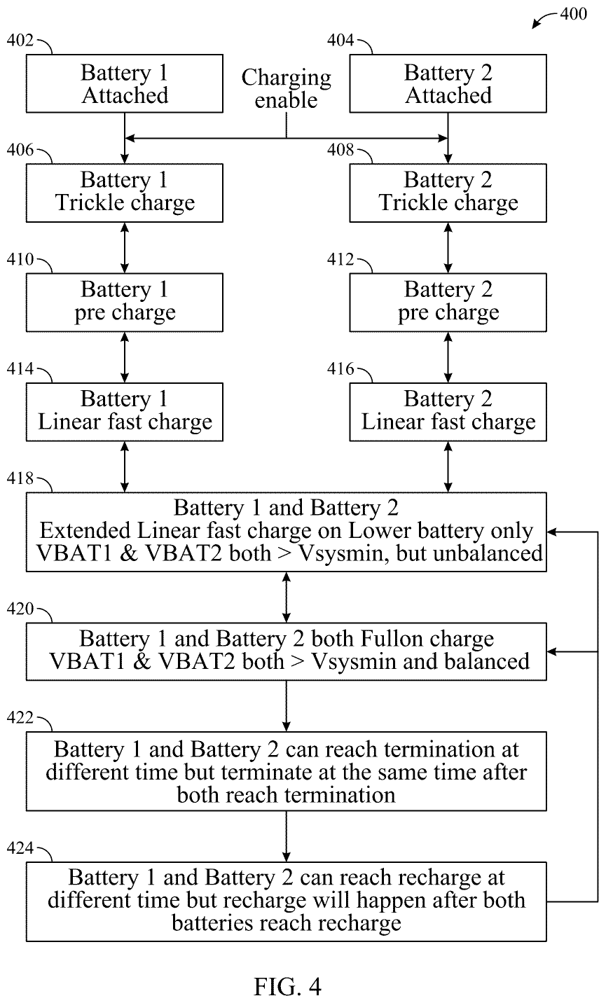

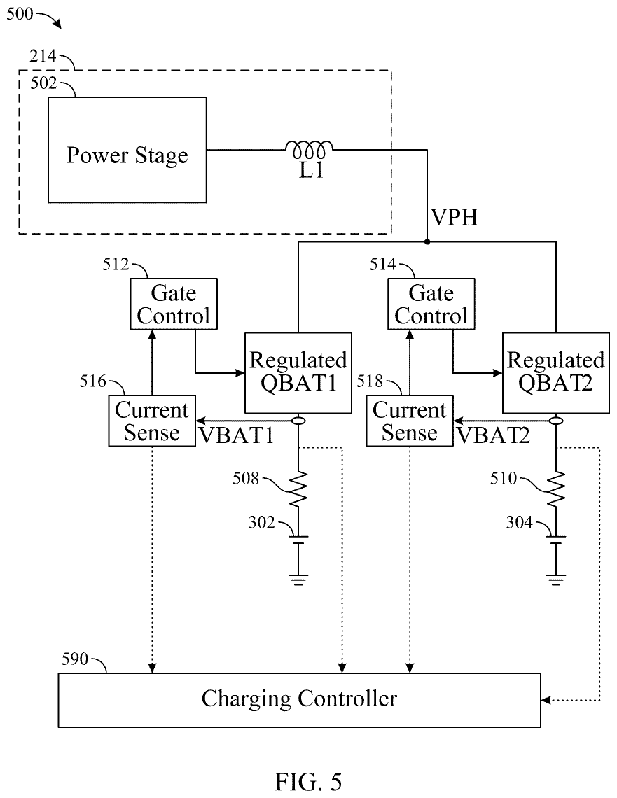

FIG. 4 is a flow diagram illustrating example operations 400 for battery charging, in accordance with certain aspects of the present disclosure. The operations 400 may be performed, for example, by a charging circuit, such as the charging circuit 500 described with respect to FIG. 5 which may include a charging controller (e.g., charging controller 590), as described in more detail herein.

In some aspects, trickle charge, precharge, and linear fast charging stages may be performed for two batteries (e.g., batteries 302, 304 shown in FIG. 3, also referred to as “battery 1” and “battery 2”) independently. For example, at block 402, battery 1 (e.g., battery 302) may be attached, and at block 404, battery 2 (e.g., battery 304) may be attached. Once charging is enabled, trickle charging may be performed for battery 1 and battery 2 at respective blocks 406, 408. After the trickle charging operations, precharging may be performed for battery 1 and battery 2 at respective blocks 410, 412. Trickle charging may be performed for a battery that is over-discharged below a threshold voltage. Precharging may be used to increase the battery voltage above a threshold voltage before fast charging phase can be performed.

Once precharging is completed, at blocks 414, 416, linear fast charging may be performed for respective batteries 1 and 2. For example, to perform a linear fast charge for a battery (e.g., battery 304), the series transistor (e.g., QBAT1) for the battery may be configured in a linear region of operation. Battery 1 and battery 2 charging before full-on charging mode may be independent. For example, even if both battery 1 and battery 2 are not attached, the trickle/precharge/linear fast charge operations for one battery may be performed without charging for the other battery, until the battery voltage of the battery being charged reaches a minimum system voltage (Vsysmin). Vsysmin may be any configured threshold voltage for the electronic system to properly operate. Battery 1 may transition from trickle charging to precharging, and from precharging to linear fast charging, without waiting for the trickle charging for battery 2 to be completed, until the voltage for the battery 1 has reached Vsysmin.

The linear fast charging may be performed until VBAT1 (e.g., voltage associated with battery 1) and VBAT2 (e.g., voltage associated with battery 2) have reached Vsysmin. At block 418, VBAT1 and VBAT2 may be compared to detect whether the battery voltages are balanced. If unbalanced (e.g., if the difference between VBAT1 and VBAT2 is greater than a threshold voltage difference), fast linear charging may be continued for the battery having a lower voltage, and the charging of the battery having a higher voltage may be stopped (or at least the charging current for the battery having the higher voltage may be reduced).

At block 420, VBAT1 and VBAT2 may be compared to identify whether VBAT1 and VBAT2 are greater than Vsysmin and balanced. If so, the batteries may transition to full-on charging mode. In full-on charging mode, the associated series transistors (QBAT1 and QBAT2) may be fully turned on (e.g., biased in saturation).

In other words, before transitioning to full-on charging mode and turning the QBATs for both batteries fully on, a VBAT voltage balance check is performed to identify whether the battery voltages are within a threshold difference (e.g., within 10 mV). If the VBATs are not balanced, the battery charging path for the battery with a higher voltage may stop charging, and the battery charging path for the battery with a lower voltage may continue to charge in extended fast linear charging mode until the lower battery voltage reaches the higher battery voltage to achieve battery voltage balance. During the extended linear fast charging stage, VPH at the output voltage node 216 may be regulated (e.g., via SMPS circuit 214) to be equal to the maximum of Vsysmin, Vbat_track1, and Vbat_track2 so that enough headroom exists in the extended linear fast charging stage to allow for continued charging. Vbat_track1 and Vbat_track2 may be voltages that are higher than and tracking VBAT1 and VBAT2, respectively, so that VPH is higher than VBAT1 and VBAT2 to provide headroom for charging.

In some aspects, the VBAT voltage balance check described herein may be performed in a continuous manner. If an unbalanced voltage is detected, a voltage unbalanced status flag may be turned on. Before transitioning to full-on mode, the VBAT voltage balance status may be checked. Once the unbalanced status is tripped to specify an unbalanced voltage, charging may transition to the extended linear fast charging stage.

In some cases, VBAT1 and VBAT2 may reach a charging termination voltage at different times (e.g., due to the resistance associated with the batteries, which are represented in FIG. 3 by resistive elements 508, 510). In some aspects, even though one of the batteries may have reached the charging termination voltage before the other battery, charging may be terminated (e.g., stopped) for both batteries at the same time at block 422. In other aspects, charging may be terminated for both batteries after both batteries reach a termination voltage.

Once charging has been stopped, battery 1 and battery 2 may discharge, and VBAT1 and VBAT2 may reach a recharge voltage threshold (e.g., a threshold at which recharging of the battery may be performed) at different times. In some aspects, even though one of the batteries may have reached the recharging voltage threshold before the other battery, recharging may begin once both battery voltages have reached the recharge voltage threshold at block 424.

FIG. 5 is a circuit diagram of a charging circuit 500 which may include the power supply circuit 300 during full-on charging mode, in accordance with certain aspects of the present disclosure. In some aspects, the charging circuit 500 may include a charging controller 590 to manage charging operations (e.g., such as operations described with respect to FIG. 4) for multiple batteries. For example, the charging controller 590 may receive an indication of VBAT1 and VBAT2 used to perform the operations described with respect to blocks 418, 420, 422, 424 of FIG. 4.

As shown, the charging circuit 500 may include the SMPS circuit 214 having a power stage 502 (e.g., including transistors Q2-Q5 shown in FIG. 2). In some aspects, QBAT1 and QBAT2 may be implemented with local independent current limit regulation circuitry in an attempt to avoid an overcurrent (OC) condition. For example, during full-on charging mode, the current for charging batteries 302, 304 may be sensed (e.g., via associated current sense circuits 516, 518 (also referred to herein as “current sensors”) sensing a current across QBAT1 and QBAT2 respectively, or by detecting a voltage across respective sensing resistive elements, such as R_{SNS1} and R_{SNS2} of FIG. 3). If the charging current for each of batteries 302, 304 reaches an upper current limit, the associated charging current may be reduced by increasing a drain-to-source resistance (Rds) (also referred to herein as an “on-resistance”) of the associated transistor QBAT1 or QBAT2. For example, a gate control circuit 512 (also referred to herein as a “gate controller”) may receive a sensed current for battery 302 from current sense circuit 516, and if the sensed current is above the upper current limit for the battery 302, the gate control circuit 512 may decrease the bias voltage for QBAT1 to increase the Rds of QBAT1. Similarly, a gate control circuit 514 may receive a sensed current for battery 304 from current sense circuit 518, and if the sensed current is above the upper current limit for the battery 304, the gate control circuit 514 may decrease the bias voltage for QBAT2 to increase the Rds of QBAT2. The local current limit regulation for the batteries may be enabled or disabled independently. When local current limit regulation is turned on for both batteries, current limiting on one or both charging paths may add a small offset in an attempt to prevent a VPH overvoltage (OV) condition. In other words, increasing the Rds of QBAT1 or QBAT2 may cause VPH to increase above an upper voltage threshold, causing an OV scenario. In some aspects, the SMPS circuit 214 may be configured to reduce VPH in an attempt to prevent the OV scenario, as described in more detail herein.

In some aspects, the SMPS circuit 214 may regulate the average charging current (e.g., total charging current flowing across inductive element L1 of FIG. 5) of the two charging paths for batteries 302, 304. For example, the total current (e.g., I_fullon_avg) supplied across inductive element L1 to the VPH node may be equal to:

$$\frac{1}{2} ( I\_fullon1 + Ifullon 2 )$$

where I_fullon1 is the current across QBAT1 during full-on mode and Ifullon2 is the current across QBAT2 during full-on mode. In some cases, if only one battery is attached (e.g., battery 302 or battery 304 is removed), the 1S2P configuration may be treated as a single series cell (e.g., 1S1P) configuration. The currents across QBAT1 and QBAT2 may be I_trickle during trickle charging, I_pre-charging during pre-charging mode, I_LFC during linear fast charging, and I_ELFC during extended linear fast charging.

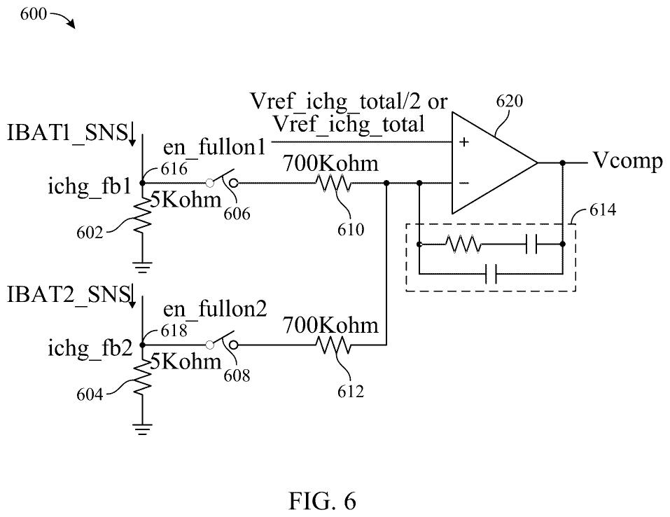

FIG. 6 illustrates an averaging circuit 600 used to control a power stage of an SMPS based on sensed battery currents, in accordance with certain aspects of the present disclosure. As shown, a sensed battery current (IBAT1_SNS) for battery 302 may flow across a resistive element 602 (e.g., a 5 kΩ resistive element), and a sensed battery current (IBAT2_SNS) for battery 304 may flow across a resistive element 604 (e.g., a 5 kΩ resistive element), generating respective voltages at nodes 616, 618. When batteries 302, 304 are in full-on charging mode, the respective switches 606, 608 are closed, coupling respective nodes 616, 618 to the negative terminal of operational amplifier 620 through respective resistive elements 610, 612 (e.g., 700 kΩ resistive elements). The negative terminal of the amplifier 620 is coupled to the output of the amplifier 620 through an impedance 614. An average voltage representing the average of IBAT1_SNS and IBAT2_SNS is generated at the negative terminal of amplifier 620. The amplifier effectively compares the average voltage to a reference voltage (labeled “Vref_ichg_total”) representing the total current supplied by the SMPS circuit 214 to the VPH node (e.g., current across inductive element L1 of FIG. 5). The amplifier 620 may generate a comparison voltage (Vcomp) that is used to control the power stage 502 of the SMPS circuit 214 (e.g., via control logic, such as logic 201 of FIG. 2) such that the total current supplied by the SMPS circuit 214 is equal to the average of IBAT1_SNS and IBAT2_SNS. In other words, the amplifier generates Vcomp such that the average voltage at the negative terminal of amplifier 620 is equal to Vref_ichg_total divided by two when the batteries are in full-on charging mode. That is, when the batteries are in full-on charging mode, Vref_ichg_total divided by two may be provided to the positive terminal of the amplifier 620. Otherwise, Vref_ich_total may be provided to the positive terminal of amplifier 620.

As described herein, the SMPS circuit 214 may be configured to reduce VPH in an attempt to prevent an OV scenario. To do so, Vref_ichg_total may be reduced so that the amplifier 620 reduces Vcomp used to control the power stage 502. Thus, VPH may be reduced to avoid the OV scenario when the Rds of QBAT1 and/or QBAT2 is increased to implement current limit regulation.

Certain aspects provide techniques for thermal management. As described, the gate control circuits 512, 514 may increase the Rds of each of QBAT1 and QBAT2 as part of implementing the local current limit regulation described herein. Due to the increase in Rds, the charging circuit temperature (e.g., temperature of QBAT1 and QBAT2) may increase. Digital thermal regulation may be used to step down the local current limit reference on both charging paths if a temperature threshold is reached due to local limit regulation. For example, the control logic (e.g., logic 201 of FIG. 2) may be used to decrease the charging current.

Certain aspects support battery insertion and removal during charging. For example, the charging circuit may detect whether one or more batteries have been removed or inserted and disable charging in response to the detection. The charging circuit may then wait a certain amount of time so that VPH has time to settle to a particular voltage. The charging circuit may then resume (e.g., enable) the charging of one or more batteries that are connected to the charging circuit. While some aspects of the present disclosure have been described for a 1S2P configuration to facilitate understanding, the aspects of the present disclosure may be applied for any number of batteries (e.g., 2 or more batteries in parallel).

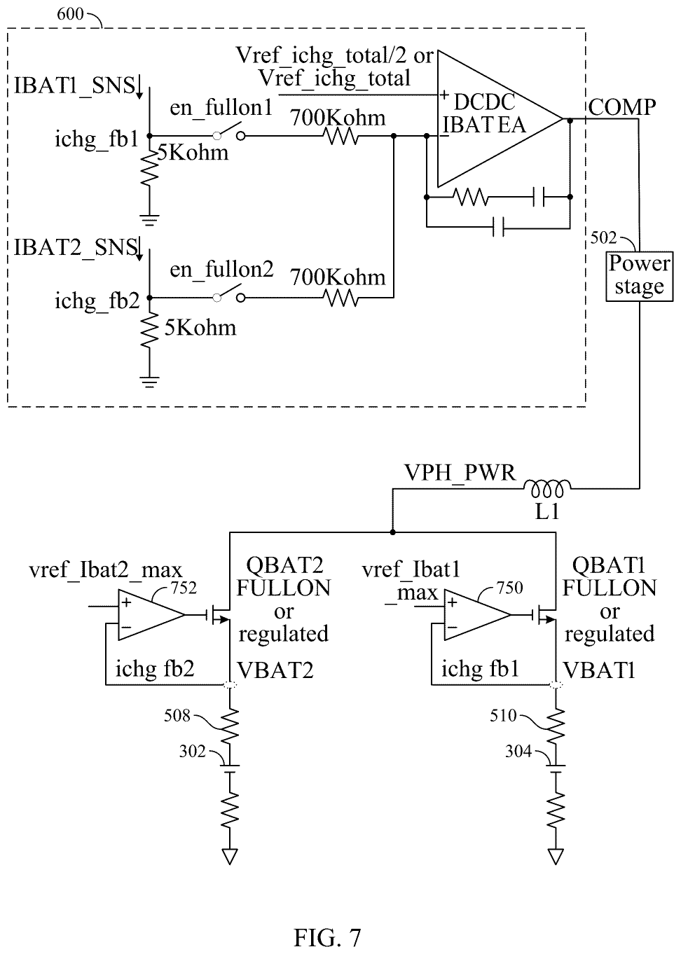

FIG. 7 illustrates the averaging circuit 600 used to control a power stage 502 of an SMPS with amplifiers 750, 752 for current control, in accordance with certain aspects of the present disclosure. As shown, amplifiers 750, 752 may be used to control QBAT1 and QBAT2, respectively. The currents supplied to batteries 304, 302 may be sensed to generate feedback voltages (labeled “ichg_fb1” and “ichg_fb2”) provided to negative terminals of respective amplifiers 750, 752. Positive inputs of amplifiers 750, 752 may be provided respective reference voltages vref_Ibat1_max and vref_Ibat2_max. The amplifiers 750, 752 may control the gates of QBAT1 and QBAT2 to control the currents supplied to batteries 304, 302. Vref_Ibat1_max and vref_Ibat2_max may be used to set the maximum currents to be supplied to respective batteries 302, 304

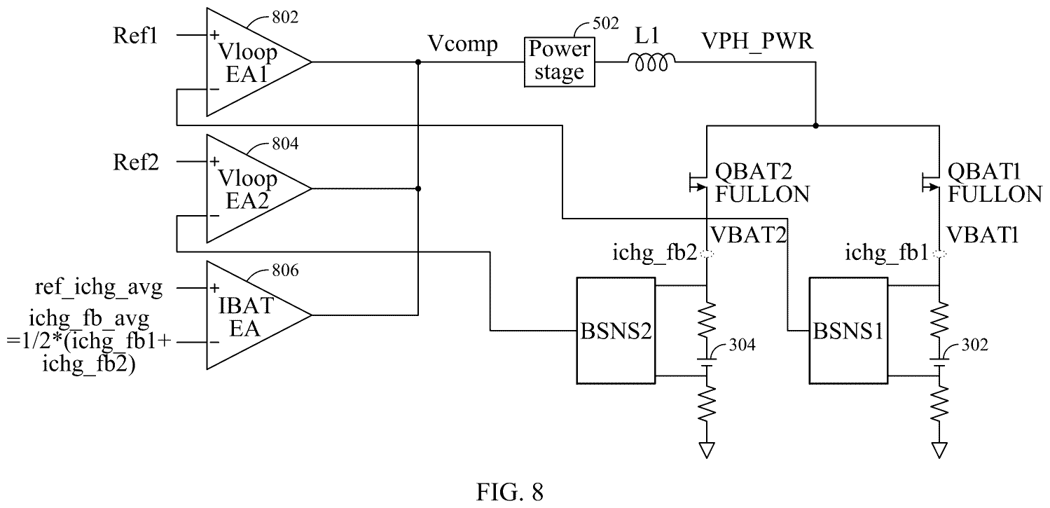

FIG. 8 is a circuit diagram of a charging circuit 800 including amplifiers 802, 804, 806 for voltage and current control, in accordance with certain aspects of the present disclosure. The amplifiers 802, 804 (e.g., voltage loop (Vloop) error amplifiers (EAs)) may receive, from battery sense circuits BSNS1 and BSNS2, battery voltages of batteries 302, 304 at negative input terminals, respectively. The positive terminals of amplifiers 802, 804 may receive reference voltages labeled Ref1 and Ref2. The outputs of amplifiers 802, 804 may be coupled to the Vcomp node to generate Vcomp and regulate the respective voltages of batteries 302, 304.

The amplifier 806 may receive a reference voltage (labeled “ref_ichg_avg”) at a negative input terminal of amplifier 806, where ref_ichg_avg is equal to the sum of ichg_fb1 and ichg_fb2 divided by two, ichg_fb1 being the sensed charging current to battery 302 and ichg_fb2 being the sensed charging current to battery 304. Thus, ref_ich_avg represents the average of currents supplied to batteries 302, 304. The output of amplifier 806 is coupled to the Vcomp node to control Vcomp and set the average charging currents of batteries 302, 304 to a reference voltage (labeled “ref_fb_avg”) provided to the positive terminal of the amplifier 806.

### Example Battery Charging Operations

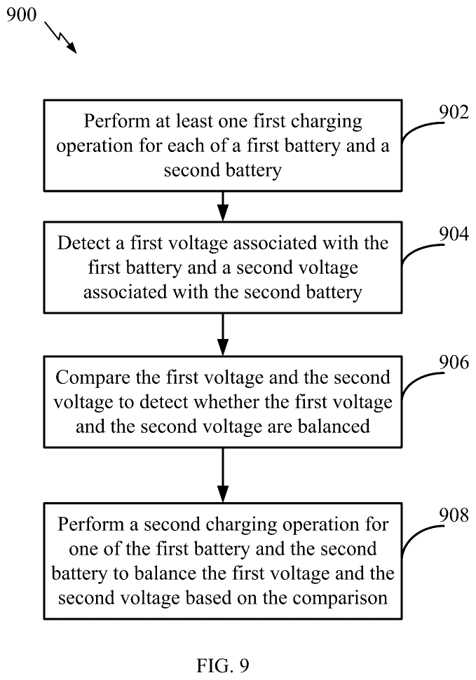

FIG. 9 is a flow diagram of example operations 900 for battery charging, in accordance with certain aspects of the present disclosure. The operations 900 may be performed by a charging circuit, such as the charging circuit 500 and/or the averaging circuit 600.

The operations may begin, at block 902, with the charging circuit performing at least one first charging operation (e.g., linear fast charging) for each of a first battery (e.g., battery 302) and a second battery (e.g., battery 304). In some aspects, performing the at least one first charging operation may include biasing a first transistor (e.g., QBAT1) coupled between a supply voltage node (e.g., VPH_PWR node) and the first battery in a linear region and biasing a second transistor (e.g., QBAT2) coupled between the supply voltage node and the second battery in a linear region.

At block 904, the charging circuit detects a first voltage (e.g., VBAT1) associated with the first battery and a second voltage associated with the second battery. At block 906, the charging circuit compares the first voltage and the second voltage to detect whether the first voltage and the second voltage are balanced. At block 908, the charging circuit performs a second charging operation (e.g., extended linear fast charging) for one of the first battery and the second battery to balance the first voltage and the second voltage based on the comparison. In some aspects, battery voltage detection and voltage balance detection may be performed in a continuous manner. Charging operations may be performed on both batteries at the same time (as long as the batteries are attached) based on battery voltage detection results and voltage balance status. For example, the first charging operation at block 902 and the second charging operation at block 708 may transition back and forth based on voltage balance status as identified using voltage detection and comparison at blocks 904, 906.

In some aspects, the second charging operation may be performed for the one of the first battery and the second battery having a lower battery voltage. Charging for another of the first battery and the second battery may be stopped during the second charging operation. In some aspects, the second charging operation to balance the first voltage and the second voltage may be performed after the first voltage and the second voltage have reached a threshold voltage (e.g., a minimum system voltage). In some aspects, detecting whether the first voltage and the second voltage are balanced may include detecting whether a difference between the first voltage and the second voltage is greater than a threshold.

In some aspects, the charging circuit may perform a full-on charging operation after the first voltage and the second voltage are balanced. Performing the full-on charging operation may include biasing a first transistor (e.g., QBAT1) coupled between a supply voltage node (e.g., VPH node) and the first battery in saturation and biasing a second transistor (e.g., QBAT2) coupled between the supply voltage node and the second battery in saturation.

In some aspects, the charging circuit may detect a charging current for the first battery and comparing the charging current to an upper charging current threshold for the first battery. The charging circuit may adjust an on-resistance (e.g., Rds) of a transistor coupled between a supply voltage node (e.g., VPH node) and the first battery based on the comparison of the charging current to the upper charging current threshold.

In some aspects, the charging circuit may detect a charging current for the first battery and a charging current for the second battery. The charging circuit may regulate a total current for charging the first battery and the second battery based on an average of the charging current for the first battery and the charging current for the second battery.

In some aspects, the charging circuit may detect a temperature associated with a charging circuit used to charge the first battery and the second battery. The charging circuit may reduce a charging current for at least one of the first battery or the second battery based on the temperature.

In some aspects, the charging circuit may detect removal or insertion of the first battery or the second battery during charging of at least one of the first battery or the second battery and stop the charging based on detecting the removal or insertion. The charging circuit may wait a configured time period after stopping to charging and enable the charging for at least one of the first battery or the second battery after the configured time period has elapsed.

### EXAMPLE ASPECTS

In addition to the various aspects described above, specific combinations of aspects are within the scope of the disclosure, some of which are detailed below:
Aspect 1: A method for battery charging, comprising: performing at least one first charging operation for each of a first battery and a second battery; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison.
Aspect 2: The method of Aspect 1, wherein the second charging operation is performed for the one of the first battery and the second battery having a lower battery voltage.
Aspect 3: The method of Aspect 2, wherein charging for another of the first battery and the second battery is stopped during the second charging operation.
Aspect 4: The method according to any of Aspects 1-3, wherein the second charging operation to balance the first voltage and the second voltage are performed after the first voltage and the second voltage have reached a minimum system voltage.
Aspect 5: The method according to any of Aspects 1-4, wherein detecting whether the first voltage and the second voltage are balanced comprises detecting whether a difference between the first voltage and the second voltage is greater than a threshold.
Aspect 6: The method according to any of Aspects 1-5, further comprising performing a full-on charging operation after the first voltage and the second voltage are balanced.
Aspect 7: The method of Aspect 6, wherein performing the full-on charging operation comprises biasing a first transistor coupled between a supply voltage node and the first battery in saturation and biasing a second transistor coupled between the supply voltage node and the second battery in saturation.
Aspect 8: The method according to any of Aspects 1-7, further comprising: detecting a charging current for the first battery; comparing the charging current to an upper charging current threshold for the first battery; and adjusting an on-resistance of a transistor coupled between a supply voltage node and the first battery based on the comparison of the charging current to the upper charging current threshold.
Aspect 9: The method according to any of Aspects 1-8, further comprising: detecting a charging current for the first battery and a charging current for the second battery; and regulating a total current for charging the first battery and the second battery based on an average of the charging current for the first battery and the charging current for the second battery.
Aspect 10: The method according to any of Aspects 1-9, further comprising: detecting a temperature associated with a charging circuit used to charge the first battery and the second battery; and reducing a charging current for at least one of the first battery or the second battery based on the temperature.
Aspect 11: The method according to any of Aspects 1-10, further comprising: detecting removal or insertion of the first battery or the second battery during charging of at least one of the first battery or the second battery; and stopping the charging based on detecting the removal or insertion; waiting a configured time period after stopping to charging; and enabling the charging for at least one of the first battery or the second battery after the configured time period has elapsed.
Aspect 12: A charging circuit, comprising: a power supply configured to perform at least one first charging operation for each of a first battery and a second battery; a charging controller coupled to the power supply and configured to: detect a first voltage associated with the first battery and a second voltage associated with the second battery; and compare the first voltage and the second voltage to detect whether the first voltage and the second voltage are balanced, wherein the power supply is further configured to perform a second charging operation for one of the first battery and the second battery to balance the first voltage and the second voltage based on the comparison.
Aspect 13: The charging circuit of Aspect 12, wherein the power supply is configured to perform the second charging operation for the one of the first battery and the second battery having a lower battery voltage.
Aspect 14: The charging circuit of Aspect 13, wherein the power supply is configured to stop charging for another of the first battery and the second battery during the second charging operation.
Aspect 15: The charging circuit according to any of Aspects 12-14, wherein the power supply is configured to perform the second charging operation to balance the first voltage and the second voltage after the first voltage and the second voltage have reached a minimum system voltage.
Aspect 16: The charging circuit according to any of Aspects 12-15, wherein, to detect whether the first voltage and the second voltage are balanced, the charging controller is configured to detect whether a difference between the first voltage and the second voltage is greater than a threshold.
Aspect 17: The charging circuit according to any of Aspects 12-16, wherein the power supply is configured to perform a full-on charging operation after the first voltage and the second voltage are balanced.
Aspect 18: The charging circuit of Aspect 17, further comprising: a first transistor coupled between a supply voltage node and the first battery; and a second transistor coupled between the supply voltage node and the second battery, wherein to perform the full-on charging operation, the charging circuit is configured to cause the first transistor and the second transistor to be biased in saturation.
Aspect 19: The charging circuit according to any of Aspects 12-18, wherein the charging controller is configured to: a current sensor configured to detect a charging current for the first battery; and a gate controller configured to adjust an on-resistance of a transistor coupled between a supply voltage node and the first battery based on a comparison of the charging current to an upper charging current threshold for the first battery.
Aspect 20: The charging circuit according to any of Aspects 12-19, further comprising at least one current sensor configured to detect a charging current for the first battery and a charging current for the second battery, wherein the power supply is configured to regulate a total current for charging the first battery and the second battery based on an average of the charging current for the first battery and the charging current for the second battery.
Aspect 21: The charging circuit according to any of Aspects 12-20, wherein: the charging controller is configured to detect a temperature associated with the charging circuit; and the power supply is configured to reduce a charging current for at least one of the first battery or the second battery based on the temperature.
Aspect 22: The charging circuit according to any of Aspects 12-21, wherein the charging controller is configured to: detect removal or insertion of the first battery or the second battery during charging of at least one of the first battery or the second battery; and stop the charging based on detecting the removal or insertion; wait a configured time period after stopping to charging; and enable the charging for at least one of the first battery or the second battery after the configured time period has elapsed.
Aspect 23: A method for battery charging, comprising: performing at least one first charging operation for each of a first battery and a second battery, wherein performing the at least one first charging operation comprises biasing a first transistor coupled between a supply voltage node and the first battery in a linear region for the first transistor and biasing a second transistor coupled between the supply voltage node and the second battery in a linear region for the second transistor; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison.
Aspect 24: The method of Aspect 23, wherein the second charging operation is performed for the one of the first battery and the second battery having a lower battery voltage.
Aspect 25: The method of Aspect 24, wherein charging for another of the first battery and the second battery is stopped during the second charging operation.
Aspect 26: The method according to any of Aspects 23-25, wherein the second charging operation to balance the first voltage and the second voltage is performed after the first voltage and the second voltage have reached a threshold voltage.
Aspect 27: The method according to any of Aspects 23-26, wherein detecting whether the first voltage and the second voltage are balanced comprises detecting whether a difference between the first voltage and the second voltage is greater than a threshold.
Aspect 28: The method according to any of Aspects 23-27, further comprising performing a full-on charging operation after the first voltage and the second voltage are balanced.
Aspect 29: The method of Aspect 28, wherein performing the full-on charging operation comprises biasing the first transistor in saturation and biasing the second transistor in saturation.
Aspect 30: The method according to any of Aspects 23-29, further comprising: detecting at least one charging current for at least one of the first battery or the second battery; and adjusting a control signal of a power supply including an output coupled to the first battery through the first transistor and to the second battery through the second transistor.
Aspect 31: The method according to any of Aspects 1-30, further comprising: detecting a charging current for the first battery and a charging current for the second battery; and regulating a total current for charging the first battery and the second battery based on an average of the charging current for the first battery and the charging current for the second battery.
Aspect 32: The method according to any of Aspects 23-31, further comprising: detecting a temperature associated with a charging circuit used to charge the first battery and the second battery; and reducing a charging current for at least one of the first battery or the second battery based on the temperature.
Aspect 33: The method according to any of Aspects 23-32, further comprising: detecting removal or insertion of the first battery or the second battery during charging of at least one of the first battery or the second battery; stopping the charging based on detecting the removal or insertion; waiting a configured time period after stopping the charging; and enabling the charging for at least one of the first battery or the second battery after the configured time period has elapsed.
Aspect 34: A charging circuit, comprising: a power supply configured to perform at least one first charging operation for each of a first battery and a second battery, wherein, during the at least one first charging operation, a first transistor coupled between a supply voltage node and the first battery is configured to be biased in a linear region for the first transistor and a second transistor coupled between the supply voltage node and the second battery is configured to be biased in a linear region for the second transistor; and a charging controller coupled to the power supply and configured to: detect a first voltage associated with the first battery and a second voltage associated with the second battery; and compare the first voltage and the second voltage to detect whether the first voltage and the second voltage are balanced, wherein the power supply is further configured to perform a second charging operation for one of the first battery and the second battery to balance the first voltage and the second voltage based on the comparison.
Aspect 35: The charging circuit of Aspect 34, wherein the power supply is configured to perform the second charging operation for the one of the first battery and the second battery having a lower battery voltage.
Aspect 36: The charging circuit of Aspect 35, wherein the power supply is configured to stop charging for another of the first battery and the second battery during the second charging operation.
Aspect 37: The charging circuit according to any of Aspects 34-36, wherein the power supply is configured to perform the second charging operation to balance the first voltage and the second voltage after the first voltage and the second voltage have reached a threshold voltage.
Aspect 38: The charging circuit according to any of Aspects 34-37, wherein, to detect whether the first voltage and the second voltage are balanced, the charging controller is configured to detect whether a difference between the first voltage and the second voltage is greater than a threshold.
Aspect 39: The charging circuit according to any of Aspects 34-38, wherein the power supply is configured to perform a full-on charging operation after the first voltage and the second voltage are balanced.
Aspect 40: The charging circuit of Aspect 39, wherein, to perform the full-on charging operation, the charging circuit is configured to cause the first transistor and the second transistor to be biased in saturation.
Aspect 41: The charging circuit according to any of Aspects 12-40, wherein: the charging circuit further comprises a current sensor configured to detect at least one charging current for at least one of the first battery or the second battery; and the charging controller is configured to adjust a control signal of the power supply including an output coupled to the first battery through the first transistor and to the second battery through the second transistor.
Aspect 42: The charging circuit according to any of Aspects 34-41, further comprising at least one current sensor configured to detect a charging current for the first battery and a charging current for the second battery, wherein the power supply is configured to regulate a total current for charging the first battery and the second battery based on an average of the charging current for the first battery and the charging current for the second battery.
Aspect 43: The charging circuit according to any of Aspects 34-42, wherein: the charging controller is configured to detect a temperature associated with the charging circuit; and the power supply is configured to reduce a charging current for at least one of the first battery or the second battery based on the temperature.
Aspect 44: The charging circuit according to any of Aspects 34-43, wherein the charging controller is configured to: detect removal or insertion of the first battery or the second battery during charging of at least one of the first battery or the second battery; stop the charging based on detecting the removal or insertion; wait a configured time period after stopping the charging; and enable the charging for at least one of the first battery or the second battery after the configured time period has elapsed.
Aspect 45: A method for battery charging, comprising: performing at least one first charging operation for each of a first battery and a second battery; detecting a first voltage associated with the first battery and a second voltage associated with the second battery; comparing the first voltage and the second voltage to detect whether the first voltage and the second voltage are balanced; and performing a second charging operation for one of the first battery and the second battery to balance the first voltage and the second voltage based on the comparison, wherein the second charging operation to balance the first voltage and the second voltage is performed after the first voltage and the second voltage have reached a threshold voltage.
Aspect 46: The method of Aspect 45, wherein the second charging operation is performed for the one of the first battery and the second battery having a lower battery voltage.
Aspect 47: The method of Aspect 46, wherein charging for another of the first battery and the second battery is stopped during the second charging operation.
Aspect 48: The method according to any of Aspects 45-47, wherein detecting whether the first voltage and the second voltage are balanced comprises detecting whether a difference between the first voltage and the second voltage is greater than a threshold.
Aspect 49: The method according to any of Aspects 45-48, further comprising performing a full-on charging operation after the first voltage and the second voltage are balanced.
Aspect 50: The method of Aspect 49, wherein performing the full-on charging operation comprises biasing a first transistor coupled between a supply voltage node and the first battery in saturation and biasing a second transistor coupled between the supply voltage node and the second battery in saturation.
Aspect 51: The method according to any of Aspects 45-50, further comprising: detecting a charging current for the first battery; comparing the charging current to an upper charging current threshold for the first battery; and adjusting an on-resistance of a transistor coupled between a supply voltage node and the first battery based on the comparison of the charging current to the upper charging current threshold.
Aspect 52: A charging circuit, comprising: a power supply configured to perform at least one first charging operation for each of a first battery and a second battery; and a charging controller coupled to the power supply and configured to: detect a first voltage associated with the first battery and a second voltage associated with the second battery; and compare the first voltage and the second voltage to detect whether the first voltage and the second voltage are balanced, wherein the power supply is further configured to perform a second charging operation for one of the first battery and the second battery to balance the first voltage and the second voltage based on the comparison, wherein the charging controller is configured to perform the second charging operation to balance the first voltage and the second voltage after the first voltage and the second voltage have reached a threshold voltage.

### ADDITIONAL CONSIDERATIONS

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for battery charging, comprising:
performing at least one first charging operation for each of a first battery and a second battery, wherein performing the at least one first charging operation comprises biasing a first transistor coupled between a supply voltage node and the first battery in a linear region for the first transistor and biasing a second transistor coupled between the supply voltage node and the second battery in a linear region for the second transistor;
detecting a first voltage associated with the first battery and a second voltage associated with the second battery;
comparing the first voltage and the second voltage to detect whether the first voltage and the second voltage are balanced; and
performing a second charging operation for one of the first battery and the second battery to balance the first voltage and the second voltage based on the comparison.

2. The method of claim 1, wherein the second charging operation is performed for the one of the first battery and the second battery having a lower battery voltage.

3. The method of claim 2, wherein charging for another of the first battery and the second battery is stopped during the second charging operation.

4. The method of claim 1, wherein the second charging operation to balance the first voltage and the second voltage is performed after the first voltage and the second voltage have reached a threshold voltage.

5. The method of claim 1, wherein detecting whether the first voltage and the second voltage are balanced comprises detecting whether a difference between the first voltage and the second voltage is greater than a threshold.

6. The method of claim 1, further comprising performing a full-on charging operation after the first voltage and the second voltage are balanced.

29. The method of claim 23, further comprising:
detecting a charging current for the first battery;
comparing the charging current to an upper charging current threshold for the first battery; and
adjusting an on-resistance of a transistor coupled between a supply voltage node and the first battery based on the comparison of the charging current to the upper charging current threshold.

30. A charging circuit, comprising:
a power supply configured to perform at least one first charging operation for each of a first battery and a second battery; and
a charging controller coupled to the power supply and configured to:
detect a first voltage associated with the first battery and a second voltage associated with the second battery; and
compare the first voltage and the second voltage to detect whether the first voltage and the second voltage are balanced, wherein the power supply is further configured to perform a second charging operation for one of the first battery and the second battery to balance the first voltage and the second voltage based on the comparison, wherein the charging controller is configured to perform the second charging operation to balance the first voltage and the second voltage after the first voltage and the second voltage have reached a threshold voltage.

7. The method of claim 6, wherein performing the full-on charging operation comprises biasing the first transistor in saturation and biasing the second transistor in saturation.

8. The method of claim 1, further comprising:
detecting at least one charging current for at least one of the first battery or the second battery; and
adjusting a control signal of a power supply including an output coupled to the first battery through the first transistor and to the second battery through the second transistor.

9. The method of claim 1, further comprising:
detecting a charging current for the first battery and a charging current for the second battery; and
regulating a total current for charging the first battery and the second battery based on an average of the charging current for the first battery and the charging current for the second battery.

10. The method of claim 1, further comprising:
detecting a temperature associated with a charging circuit used to charge the first battery and the second battery; and
reducing a charging current for at least one of the first battery or the second battery based on the temperature.

11. The method of claim 1, further comprising:
detecting removal or insertion of the first battery or the second battery during charging of at least one of the first battery or the second battery;
stopping the charging based on detecting the removal or insertion;
waiting a configured time period after stopping the charging; and
enabling the charging for at least one of the first battery or the second battery after the configured time period has elapsed.

12. A charging circuit, comprising:
a power supply configured to perform at least one first charging operation for each of a first battery and a second battery, wherein, during the at least one first charging operation, a first transistor coupled between a supply voltage node and the first battery is configured to be biased in a linear region for the first transistor and a second transistor coupled between the supply voltage node and the second battery is configured to be biased in a linear region for the second transistor; and
a charging controller coupled to the power supply and configured to:
detect a first voltage associated with the first battery and a second voltage associated with the second battery; and
compare the first voltage and the second voltage to detect whether the first voltage and the second voltage are balanced, wherein the power supply is further configured to perform a second charging operation for one of the first battery and the second battery to balance the first voltage and the second voltage based on the comparison.

13. The charging circuit of claim 12, wherein the power supply is configured to perform the second charging operation for the one of the first battery and the second battery having a lower battery voltage.

14. The charging circuit of claim 13, wherein the power supply is configured to stop charging for another of the first battery and the second battery during the second charging operation.

15. The charging circuit of claim 12, wherein the power supply is configured to perform the second charging operation to balance the first voltage and the second voltage after the first voltage and the second voltage have reached a threshold voltage.

16. The charging circuit of claim 12, wherein, to detect whether the first voltage and the second voltage are balanced, the charging controller is configured to detect whether a difference between the first voltage and the second voltage is greater than a threshold.

17. The charging circuit of claim 12, wherein the power supply is configured to perform a full-on charging operation after the first voltage and the second voltage are balanced.

18. The charging circuit of claim 17, wherein, to perform the full-on charging operation, the charging circuit is configured to cause the first transistor and the second transistor to be biased in saturation.

19. The charging circuit of claim 12, wherein:
the charging circuit further comprises a current sensor configured to detect at least one charging current for at least one of the first battery or the second battery; and
the charging controller is configured to adjust a control signal of the power supply including an output coupled to the first battery through the first transistor and to the second battery through the second transistor.

20. The charging circuit of claim 12, further comprising at least one current sensor configured to detect a charging current for the first battery and a charging current for the second battery, wherein the power supply is configured to regulate a total current for charging the first battery and the second battery based on an average of the charging current for the first battery and the charging current for the second battery.

21. The charging circuit of claim 12, wherein:
the charging controller is configured to detect a temperature associated with the charging circuit; and
the power supply is configured to reduce a charging current for at least one of the first battery or the second battery based on the temperature.

22. The charging circuit of claim 12, wherein the charging controller is configured to:
detect removal or insertion of the first battery or the second battery during charging of at least one of the first battery or the second battery;
stop the charging based on detecting the removal or insertion;
wait a configured time period after stopping the charging; and
enable the charging for at least one of the first battery or the second battery after the configured time period has elapsed.

23. A method for battery charging, comprising:
performing at least one first charging operation for each of a first battery and a second battery;
detecting a first voltage associated with the first battery and a second voltage associated with the second battery;
comparing the first voltage and the second voltage to detect whether the first voltage and the second voltage are balanced; and
performing a second charging operation for one of the first battery and the second battery to balance the first voltage and the second voltage based on the comparison, wherein the second charging operation to balance the first voltage and the second voltage is performed after the first voltage and the second voltage have reached a threshold voltage.

24. The method of claim 23, wherein the second charging operation is performed for the one of the first battery and the second battery having a lower battery voltage.

25. The method of claim 24, wherein charging for another of the first battery and the second battery is stopped during the second charging operation.

26. The method of claim 23, wherein detecting whether the first voltage and the second voltage are balanced comprises detecting whether a difference between the first voltage and the second voltage is greater than a threshold.

27. The method of claim 23, further comprising performing a full-on charging operation after the first voltage and the second voltage are balanced.

28. The method of claim 27, wherein performing the full-on charging operation comprises biasing a first transistor coupled between a supply voltage node and the first battery in saturation and biasing a second transistor coupled between the supply voltage node and the second battery in saturation.
